(19) United States
(12) Patent Application Publication
(10) Pub. No.: US 2012/0278413 A1
(43) Pub. Date: Nov. 1, 2012

(54) METHOD AND SYSTEM FOR USER INITIATED ELECTRONIC MESSAGING

(76) Inventors: Tom Walsh, Tecumseh, MI (US); Steven J. Catani, Athens, GA (US); Maurice Collins, Chelsea, MI (US); Lauren Didyk, Plymouth, MI (US); Helene Gidley, Ann Arbor, MI (US); David Gregorka, Ann Arbor, MI (US); John Hetrick, Ann Arbor, MI (US); Jeff Matthes, Ypsilanti, MI (US); Tom Sox, Ambler, PA (US); Victor Strecher, Ann Arbor, MI (US)

(21) Appl. No.: 13/457,866

(22) Filed: Apr. 27, 2012

Related U.S. Application Data
(60) Provisional application No. 61/480,411, filed on Apr. 29, 2011.

(51) Int. Cl. G06F 15/16

(52) U.S. Cl. 709/206

(57) ABSTRACT

A method and system for providing personalized message delivery to one or more users is disclosed. In accordance with the method and system, data descriptive of two or more events in the one or more users' lives is gathered, analyzed and used to determine priority of messages; and personalized message delivery is provided to the one or more users based upon the priority of messages. The method and system may employ user's emotions to correlate holistic messages considered important by the user.

### CROSS REFERENCE TO RELATED APPLICATIONS

This application claims priority from U.S. Provisional Application Ser. No. 61/480,411, filed Apr. 29, 2011, the contents of which are hereby incorporated by reference in their entirety.

### FIELD OF THE INVENTION

The present invention relates to a method and system for providing message delivery to one or more users. The method and system of the invention, which employ events, needs and user emotions, are particularly useful in prioritizing messages considered important for the user.

### BACKGROUND OF THE INVENTION

Different methods and/or systems for the delivery of information to individuals are known. For example, U.S. Pat. No. 7,949,712 to AT&T Intellectual Property L.L.P., discloses a method for deploying a high availability presence engine for instant messaging that includes: receiving a user's presence change information in a global table; updating the global table to reflect the change in the user's presence information; and sending updated presence information on the user to local tables of contacts affected by the change in the user's presence; and U.S. Pat. Nos. 7,756,744 and 7,895,078 to Dotomi Inc. disclose a method for messaging over a data network, comprising: i) providing an Administration Server (AS) in which user portfolios are stored, said AS being in communication with a terminal belonging to a user; ii) allowing every registered user to generate and update one or more user portfolio(s) containing information relative to Providers and/or individuals the messages of which the user is willing to view; and iii) displaying to one or more users on their terminal messages according to the information contained in the user portfolio. While many of these methods and/or systems provide information to the user, they lack the intuitiveness to decide when the message will be most effective, based on learned patterns, user feedback, lack of user feedback and user preferences as well as what the content of the message should be.

Different methods and/or systems for assisting communication between members of a team are also known. For example, U.S. Pat. No. 8,069,131 to Luechtefeld et al. discloses an artificially intelligent or rule-based system to assist teams or groups by improving the communication process between members of the team or group. U.S. Pat. No. 7,996,257 to International Business Machines Corporation (hereinafter referred to as IBM) discloses mechanisms for collecting, calculating, and reporting quantifiable peer feedback on relative contributions of team members. U.S. Pat. No. 7,584,114 to IBM discloses a method for integrating project events on a team collaboration server with personal calendars. U.S. Pat. No. 7,072,940 to Ford Motor Company discloses methods and apparatus for managing data and information between diverse organizations and data management systems.

U.S. Published Application No. 20120036015 to Sheikh discloses a method to improve the relevancy of rendered advertising material to one or more consumers based on user-defined preferences, geolocation, and user-granted permission.

U.S. Published Application No. 20110112881 to Malhotra et al. discloses a system and method for helping users perform and manage actions on their to-do lists tasks by making it fun, rewarding and engaging. Malhotra et al. discloses that the system and method facilitate the interaction of a user with to-do list task items with those who can influence the user to take action and those that stand to benefit from the performance of the to-do list task items.

Effective communication is vital. While the methods and/or systems discussed above may assist communication, they do not provide a method and/or a system that employs events and third party influences to prioritize and correlate messages considered relevant for a user (as determined both by user input (passive, not active) and by systematic input (learnings).

U.S. Pat. No. 8,126,712 to Nippon Telegraph and Telephone Corporation discloses an information communication terminal (100) that includes: a speech recognition module (6) for recognizing speech information to identify a plurality of words in the recognized speech information; a storage medium (20) for storing keyword extraction condition setting data (24) in which a condition for extracting a keyword is set; a keyword extraction module (8) for reading the keyword extraction condition setting data (24) to extract a plurality of keywords from the plurality of words; a related information acquisition module (11) for acquiring related information related to a plurality of keywords; and a related information output module (14) for providing related information to a monitor (2). The patent discloses that information communication terminal (100) may further include an emotion information processing module (51) and a speech output module (57). The emotion information processing module (51) includes an emotion recognition module (52), an emotion information transmission module (53), an emotion information reception module (54), and an emotion information display module (55).

U.S. Pat. No. 8,132,229 to International Business Machines Corporation (IBM) discloses a method and apparatus for controlling the distribution of data that, e.g., characterizes a user's emotional state or is capable of being used to characterize the user's emotional state and/or describes a physiological parameter. The patent discloses that a rule set(s) is provided to regulate the distribution of the data to requesting applications. In order for an application to have access to the data, the relevant rules of the rule set must be satisfied.

U.S. Pat. No. 8,125,314 to IBM discloses a method and system for determining user interest in media. The patent discloses that the method and system distinguish between user physical exertion biometric feedback and user emotional interest in a media stream.

U.S. Pat. No. 8,109,874 to Samsung Electronics Co., Ltd. discloses a mobile device capable of performing biomedical signal measurement and a health care method using the same. The patent discloses that the mobile device comprises a biomedical signal measurement module for detecting biomedical signals from a user's body, classifying the detected biomedical signals by respective signals and outputting the classified signals; and a health care module for analyzing a user's emotional state and physical condition based on the biomedical signals input from the biomedical signal measurement module and user's physical information.

The methods and/or systems discussed above do not provide a method and/or a system that employs user emotions to prioritize and correlate messages considered relevant for a user (as determined both by user input (passive, not active) and by systematic input (learnings).

### SUMMARY OF THE INVENTION

The present invention is directed to a method for providing personalized message delivery to one or more users, comprising: gathering data descriptive of two or more events in the one or more users life, wherein the two or more events include an emotion of the one or more users; analyzing the data to determine priority of the messages; and providing the personalized message delivery to the one or more user.

The present invention is also directed to a system for providing personalized message delivery to one or more users, comprising: at least one user interface; a server, wherein the server comprises software, wherein the software gathers data descriptive of two or more events in the one or more users life, analyzes the data to determine priority of messages, and employs the priority of messages to determine personalized message delivery of the messages to the one or more users, wherein the two or more events include an emotion of the one or more users; and a transmitter in communication with the processor and the at least one user interface, wherein the transmitter provides the personalized message delivery of the messages to the one or more users through the at least one user interface.

### DESCRIPTION OF THE DRAWINGS

FIG. 1 is a flowchart showing an example of a method and system for providing message delivery to one or more users that may be used in accordance with the present invention.

FIG. 2 is a schematic that illustrates in more detail steps and the corresponding factors of those steps that may be implemented when using the method and system of the present invention.

FIG. 3 is a schematic that illustrates a general sequence of events that may be followed when using the method and system of the present invention.

FIG. 4 is a schematic that illustrates a server that may be employed when using the method and system of the present invention.

FIG. 5 is a schematic that illustrates feedback components that may be employed to generate and deliver Holistic Messages when using the system and method of the present invention.

FIG. 6 is a schematic that illustrates emotion detection components that may be employed to generate and deliver Holistic Messages when using the system and method of the present invention.

### DETAILED DESCRIPTION OF THE INVENTION

The present invention provides a method and system to correlate messages corresponding to events, emotions and input from a user. The method and system of the invention permit effective and personalized communication to the user.

### Definitions

Unless defined otherwise, all technical terms used herein have the same meaning as commonly understood by one of ordinary skill in the art to which the invention belongs. Also, all publications, patent applications, patents, and other references that may be mentioned herein are incorporated herein by reference.

“Biometric Device Initiated Feedback” as used herein Biometric Device Initiated Feedback refers to information collected from one or more biometric devices that can allow for messaging based on the information and that help identify the effectiveness of each electronic message (i.e., mini-evaluation).

“Correlated Events” as used herein Correlated Events generally have been evaluated (by the system) and a commonality has been identified between two or more linking the messages/events together in some macro or micro subject matter.

“Correlation Score” as used herein a Correlation Score can be a numerical value that shows how correlated two or more Events/messages are to each other.

“Economic Buyer” as used herein Economic Buyer generally includes an entity that promotes and/or sponsors a User's participation in a program that is based upon a common theme. For example, an Economic Buyer can be an employer, a health plan, a third party administrator, and/or a pharmaceutical company who pays for the program and/or selects and/or determines the scope of enrollment of the User in the program.

“Emotion Detection System” (“EDS”) as used herein EDS, which can extract perceived emotions from a particular User response, e.g., tone of voice, post on a website, e-mail message, etc. The perceived emotions may be used to correlate and prioritize Events/messages and maximize effectiveness of the messages.

“Event(s)” as used herein Event(s) is/are data input to the system that is derived from various sources, including, but not limited to, User input.

“Geo-Social Data” as used herein Geo-Social Data includes data from the assessment of locations recorded using location-acquisition technologies (e.g., GPS, phone “check in” applications, etc.) that assist with generating life patterns, and which associate Users to places they frequently visit. Geo-Social Data includes Normative Data generated for a specific location recorded, or to similar locations.

“Holistic Message” as used herein a Holistic Message is generally a more eloquently constructed message, that is worded in such a way that pieces are not merely strung together but construction of the message as a whole is based on the sum of its parts. Messages are “holistically” created, as compared to the current form of “tailored” messaging, which is more like a series of prescripted messages packaged together in a logical way.

“Importance Score” as used herein an Importance Score generally includes a method of prioritizing Events and Event Correlated messages. For example, it may include the system assigning a numerical value to each specific Event or collectively to a group of Correlated Events by the system for prioritization.

“Just in Time Message (‘JIT Message’)” as used herein JIT Message is a personalized response that may be made in message form, advertisement, reminder, etc., which is conveyed effectively to the User by prioritizing and correlating the message using specific pertinent data prior to the conveyance. As indicated below, Just in Time indicates that the delivery is at the appropriate time, frequency, tone, method and/or mode of delivery for the message content in accordance with User's Preferences (includes both internal and external input).

“Message Combine” as used herein a Message Combine can act as a “think funnel”. I.e., Micro events can be correlated with one another, and affect the overall correlation score of macro topics (e.g., cold outside>walking reminder>exercise>overall health>diabetes>reminder>blood sugar). Message Combine works on foundation messaging as the highest priority/highest level of correlation, then works down the scale of related Events (e.g., diabetes, depression, insomnia—messaging may focus on the central topic of exercise based on priority/effectiveness of all messages).

“Network Access Device” as used herein a Network Access Device means a device for accessing a communications network capable of transforming and receiving digital data.

“Normative Data” as used herein Normative Data includes data which represents the normal or average response or impact from any given event, (e.g., news, etc.), across various levels, (e.g., age, sex, etc.), used to compare a User's response with an objective external standard. Normative Data can also include data contained in available databases that provide population level data as a reference point.

“Now State” as used herein Now State means the best time, frequency, tone, method and/or mode for delivery of a message to a User as determined by an input describing the User's state of mind at a fixed point in time. The input could be from User input or derived from a reporting device.

“Overseer” as used herein an Overseer refers generally to a monitor for a Pre-determined Third Party. The Overseer may be a person or an algorithm that controls what messages are being sent and to whom. The Overseer may act as a filter, e.g., to prevent inappropriate messages coming from the Pre-determined Third Party. For example, an Economic Buyer may have a strict human resources (HR) policy that prevents certain types of messages from being generated. The Overseer could perform screening of messages in light of certain rules, evaluate the messages and accept, reject or adjust the messaging so it is appropriate given the environment/spirit in which it is being sent.

“Pre-determined Third Party” as used herein a Pre-determined Third Party may be a pre-selected team leader, party organizer, counselor, inspirational storyteller, Economic Buyer, etc. The Pre-determined Third Party may be selected by the Economic Buyer, the system itself, and/or the User. The function of the Pre-determined Third Party may be to motivate and direct the User(s). For example, the Pre-determined Third Party could motivate and organize people in an organization to, e.g., do good things, be healthy, be happy, be full of energy, etc.“Present Responsiveness” as used herein Present Responsiveness is a determination of whether or not and how frequently a User responds to certain modalities and messages in order to determine the effectiveness of the messages.

“Real Time” as used herein Real Time is a process, action or transaction that involves updating information without artificial delay, i.e., at the same rate that the information is received.

“Smart Team Message(s)” as used herein a Smart Team Message is a communication to a User(s) that incorporates User's Preferences and a Team's characteristics/objectives to convey a message in a personalized and effective way by providing correlated and prioritized message delivery.

“Source Agnostic” as used herein Source Agnostic refers to all data being treated as input “events” without regard to their source. The data is formatted in a way that is not specific to its source (e.g., using standard protocols such as XML). The system may also use data from sources such as GPS location for mobile Users; weather information; geographical information; local events; time and date; news and current news, as well as the systems current sources (e.g., behavioral science, health and wellness, medical, health plan, employer data, etc.). This does not mean all data points are equal. Data is differentially weighted to impact how it is prioritized and/or used to construct messages.

“System Initiated Feedback” as used herein System Initiated Feedback generally refers to feedback from the system that helps determine the appropriate message by evaluating multiple data sources and events that pertain uniquely to the individual. In response to this unique information, the system uses pre-established rules to tailor messaging to the individual, with the rules structured so that the provided messaging is more effective than conventional messaging in positively affecting the User's actions and health outcomes. E.g., the system determines that the User needs positive reinforcement to not smoke at a particular time of day during his/her morning commute. This is a passive message based on the sum total of inputs relating to the User experience.

“Team” as used herein a Team generally includes individuals that share a set of qualities/characteristics used to achieve a common goal or target. E.g., athletic teams, business teams, support groups, members of an entity, etc.

“Third Party Dashboard” as used herein the Third Party Dashboard includes a User interface designed for the Pre-determined Third Party message indicator. For example, in some applications a manager of a group could log on and send a message to the group. In other applications, a coach could log on and send a message to his/her team. However, unlike conventional systems, limited functionality is afforded through the Third Party Dashboard based on stakeholder input. Stakeholders or administrators using the Third Party Dashboard would be able to select from a full list of features in order to arrange the interface to serve the needs of different User profiles.

“Transport Agnostic” as used herein Transport Agnostic includes data formatted to be used by multiple systems or devices (meaning standard data types and protocols are used so as not to restrict the data for any given system). Taken a step further, currently a User getting an e-mail may have a slightly different message than someone who accesses his or her information on the web. The system can ensure that the message(s) are formatted so that the meaning (core message) of the content is the same regardless of how they are received/transported.

“User” as used herein a User may be a person, team, company, or organization utilizing the message delivery system.

“User Initiated Feedback” as used herein User initiated Feedback generally refers to feedback that is generated by the system as the result of an end User of the system triggering the feedback. It is different from System-Initiated Feedback, which is passive. I.e., User Initiated Feedback occurs when the User indicates they are in need of support, in need of feedback, or looking for specific information. For example, the User may communicate this need by direct input from a mobile device, a PC, or by other means (e.g., interactive voice response (IVR), kiosk, biometric or fitness measuring device).

“User's Preferences” as used herein User's Preferences are the preferences of a specific User as to the timing, frequency, message tone, method and/or mode of receiving/sharing information.

Commonly assigned co-pending U.S. application Ser. No. 13/283,039, filed on Nov. 27, 2011, entitled “METHOD AND SYSTEM FOR PERSONALIZED MESSAGE DELIVERY”, the entire contents of which are incorporated herein by reference, provides a method and system for determining and implementing user preferences, normative data, location, and time, including, e.g., time of day, day of week and month of year, for the delivery of Just in Time Messages in a way innocuous to the user.

Commonly assigned co-pending U.S. application Ser. No. 13/336,080, filed on Dec. 23, 2011, entitled “METHOD AND SYSTEM FOR AUTOMATED TEAM SUPPORT MESSAGE DELIVERY”, the entire contents of which are incorporated herein by reference, provides a method and system for providing message delivery to one or more members of one or more teams of users.

Commonly assigned co-pending U.S. application Ser. No. 61/480,408, filed on Apr. 29, 2011, entitled “METHOD AND SYSTEM FOR MESSAGE DELIVERY EMPLOYING THIRD PARTY INFLUENCES”, the entire contents of which are incorporated herein by reference, provides a method and system for providing message delivery to one or more users. The method and system, which employ user events and third party influences, are particularly useful in the correlation of messages considered important for the user.

The method and system of the invention, which employ user events and emotions, are particularly useful in the correlation of messages considered relevant for a user at a particular point in time.

The invention is exemplified in the examples below.

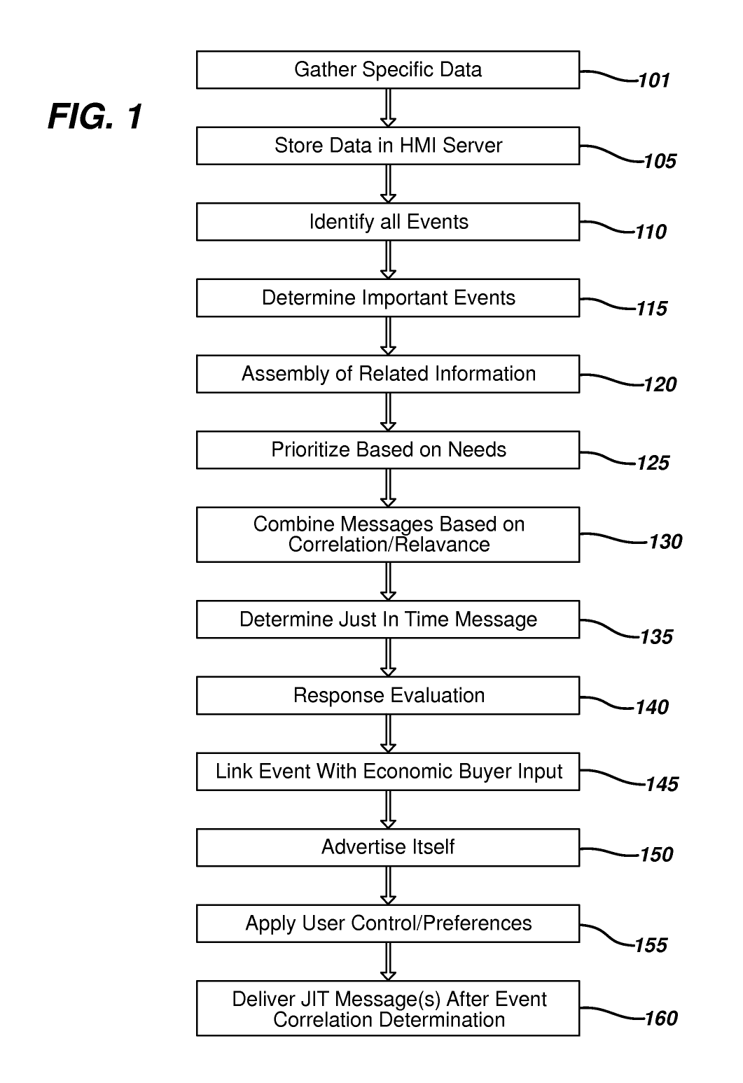

FIG. 1 is a flowchart showing an example of a method and system for providing message delivery to one or more users that may be used in accordance with the present invention. Referring to FIG. 1, people's time and attention span is limited. As such, for effective message construction, delivery, and assimilation, it would be useful to prioritize and correlate electronic messages to Events and emotions in the life of a User. According to an embodiment of the invention, at 101 the system gathers data specific to each User continuously. Data may come into a server from direct or indirect inputs, from the User, from a Pre-determined Third Party, and/or from different non-users, through one or more of an array of different Network Access Devices. At 105, data received in a consistent format and in Real Time can be supported by the system and may be stored in a designated database in the server. At 110, data received may be classified to indentify past events and/or anticipate upcoming events in the life of the User. After specific foreseeable events are identified, Events may then be linked with different behavioral topics by the system using User specific and Pre-determined Third Party data to determine an Importance Score for each Event generated 115. Upon formulating an Importance Score, at 120, the system may begin to combine information, including User's emotions and state of mind, to assemble Holistic Messages, to decrease the number of messages and maximize the effectiveness of the messages for the User.

At 125, the needs, emotions, state of mind and/or User's Preferences can also be used by the System to prioritize the message(s). The needs may also be influenced by Pre-determined Third Parties. A Pre-determined Third Party should be the person who is best equipped to be the leader in health related initiatives and act as an administrator for the Third Party Dashboard. For example, the Pre-determined Third Party in a company may be the person who knows everyone by name, knows about their families, their work struggles, etc. and generally cares about everyone in the office. However, input can be controlled by the system so that the information is in harmony with the goal, principle, overall functionality of the message, etc., by means of an Overseer. E.g., the Overseer may specify to the system the type of message a Pre-determined Third Party wants to send out on a particular day. Additionally, the system may include a medical consultant that can evaluate the content periodically or continuously for accuracy and relevance, and inputs new data into the system based on the latest research specific to a sub-set of a population. The medical consultant can also use behavioral science and medical principles to analyze a User's emotions to further ensure that the content of the message maximizes the effectiveness of the message and provides the intended influence of the respective Pre-determined Third Party.

Further prioritization can occur and electronic messages may be generated and scheduled for delivery sequentially to specific future Events with a high probability of occurring 130. At 135, a JIT Message determination may also be implemented to determine effective means of delivery. At 140, the User or other comparable individual(s)' response(s) to an identical or similar message can generate data resulting from the effectiveness it has on the individual, which may be recorded for implementation in future determinations of content and delivery of the electronic messages.

Additional features may be implemented by the system. For example, the User's events and scope of participation can be limited by an Economic Buyer. The Economic Buyer can have power to customize the program causing it to focus on selected behavioral topics and/or elected Events 145 (i.e., event influenced electronic messages). The Economic Buyer may also use the system to “advertise itself” 150. The “advertise itself” option can allow the incorporation of pre-selected messages by the Economic Buyer into the program. The User's Preferences may also be merged with the Economic Buyer's settings to correlate events and scope of participation of the User 155. The system subsequently may cause the delivery of JIT Message(s) that are correlated with Events, emotions of the User 155 providing effective conveyance of Holistic Messages to the User.

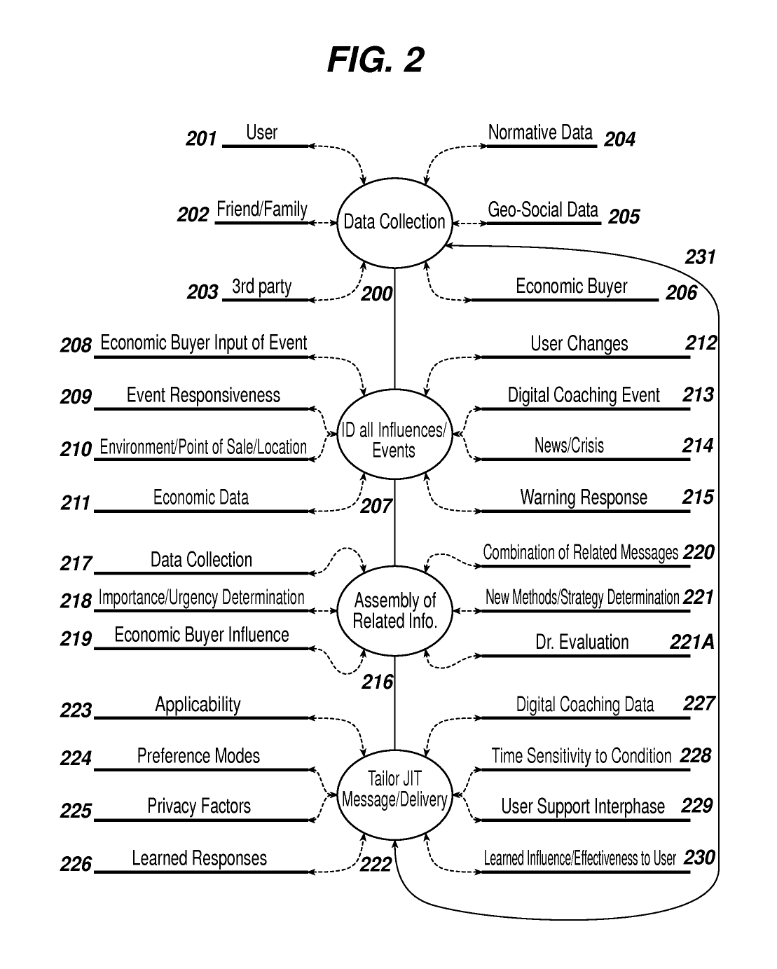

FIG. 2 is a schematic that illustrates in more detail the steps and corresponding factors of those steps that may be implemented when using the method and system of the present invention. Referring to FIG. 2, at 200, data collection applicable to the User can include data received from different avenues. The data received must be in a consistent format and in real time. The User 201 can supply data to the Network Access Device in different ways. User supplied data includes but is not limited to data taken from web/paper questionnaires/consultations, medical devices, the system itself, biometric devices, wireless devices, PC, employers, etc.

Friends and family 202 may also provide relevant information about the User through different/same mediums. They can express concerns or provide valuable information about the User through any medium supported by the system. An example of a medium that may be implemented without burdening this group is social networks. Social networks are used every day and may provide Source Agnostic information in Real Time, about the User, without requiring additional effort from friends and family.

Other third parties 203 may also provide helpful and in some applications valuable data to the system. If not selected as the Pre-determined Third Party and/or the medical consultant described previously, other third parties who may additionally provide input include the User's Economic Buyer, physician, coach, co-worker, manager, project manager, etc. These third parties, who can provide data in everyday situations using mediums supported by the system, may give useful/essential data to the system for specific topics. For example, in one scenario where a third party notices or notes a change in the individual's activities, preferences, or behavior, the system may detect the change from the data provided by the third party. In another scenario, the Economic Buyer and/or the Pre-determined Third Party may elect certain behavioral topics, assessments, modes, etc. for implementation by the system 206. In some applications, because the Economic Buyer has the ability to input information that influences the User(s), the influence can be stratified to the appropriate groups using the Economic Buyer as the Pre-determined Third Party. For example, where the doctor is the Economic Buyer and has a closed health care plan, he/she can send a message to his patients in the group.

Normative Data 204 and Geo-Social Data 205 can also help identify, correlate and associate responsiveness of messages to particular Events and/or Team goals/objectives. An example of where Normative Data may be useful includes data collected from a reaction to an Event from a particular group of people who share similar characteristics. The system can categorize, prioritize and correlate the data received which resulted from the reaction to the Event into the Importance Score determination. Finally, data generated from the response and effect of these, Smart Team Messages and/or JIT messages is Source and/or Transport Agnostic, which may be used by the system to determine User Preferences for future interaction and Holistic messages.

Essentially, the influence of the Pre-determined Third Parties and others may turn to specific and general Events in Users' lives. Using algorithms capable of applying sets of factors and Correlation Scores, the system may identify those Events important to the User 207. Events can subsequently be tagged/categorized using the additional factors. Additional factors that can influence electronic messages may include but are not limited to Economic Buyer Input of Events 208, responsiveness to an Event 209, location/environment where an Event takes place 210, economic data 211, User's Preferences 212, a digital coaching Event created by the system 213, currents news data 214, responses to Event warnings 215, etc. These factors for the Importance Score determination can be programmed into the algorithms in the server and the system can allow inputs from the monitoring party for the modification of these to maximize the effectiveness of the program.

After obtaining the Correlation Score for identified Events, the system can gather pertinent information for Holistic Message assembly using the information collected and stored in the systems databases 216. The content of the message may be determined using the Event(s)' information/data 217. Behavioral science inputs can allow for an Importance Score determination for the information/data. The Importance Score determination will manipulate the content of messages and the priority among the messages generated 218. Other things aside from behavioral science can also be used for content and priority determination. For example, an Economic Buyer may manipulate the content of the message 219. An example of how/when this may occur is when the Economic Buyer chooses to advertise itself by selecting preselected messages from the system. However, the system may maximize effectiveness by Holistically constructing, and delivering the message based on the User's emotions at the time of the delivery.

After the content and priority determination, the system can use a Message Combine 220 to provide Holistic Message(s), which can minimize the amount of messages and increase the probability of effective reception of the message by the User. Using behavioral science, the system can also strategize the messages and provide new methods of delivery generating data to tailor the delivery and content of future messages 221. For example, in some applications, a Holistic Message can be Event triggered by a manager but delivered by the Pre-determined Third Party influence to ensure a positive effective message result. At 221A, the Overseer and/or the medical consultant can additionally review the functionality of the message and allow it desired. For example, the system can include a filter/search function with drag in data elements to build the message, so where a message is to be targeted to men over 40 and colon health, the medical consultant can assist in crafting the message using the latest studies pertaining to colon health in men over 40. Furthermore, the medical consultant may also assist in the determination of when the particular message can elevate efficacy according to the emotional estate of the User as determined by the system.

The conveyance timing and method of the message may be tailored to the User using JIT Messaging 222. Determining the applicability of the message in relation to the emotional state of mind and respective activity the User may be performing/taking part in, can ensure that the message is engaging, thus maximizing the effectiveness of the message 223. For example, by using the data collected to track the User's everyday activities, the system can correlate specific messages with high probability occurring activities to specific times of the day, month, etc. The User Preferences and access to devices at specific times is also taken into account in the delivery 224. For example, it can be determined that the User has access to a computer during workday hours specific to the User. Additionally, privacy factors and access to information can be protected to protect the individual's privacy and ensure truthful participation of the User 225. The system may also learn responses from the User and shape the program accordingly 226.

Digital coaching may also be possible 227. The Economic Buyer, Pre-determined Third Party, or System can recommend or assign a coach or a digital “buddy” for encouragement. The interaction of more than one User in the program can be done by invitation and be known to Users, or can remain anonymous if desired. Coaches may also be recruited by the system based on Biometric Device Initiated Feedback, System Initiated Feedback, and/or User Initiated Feedback and data inputted/collected from them is weighted for the electronic messages accordingly.

At 228 the participation of the User may be tracked and time factors specific to the User can be implemented in the delivery of the message. For example, for some Users it may be more effective to convey the message as close to the occurrence of the Event vs. others, as soon as possible to allow for anticipation and preparation accordingly. In addition, the User can be more susceptible to adequate reception of the particular message when he/she is happy, sad, focused, etc., consequently, the system also correlates the optimal emotional state of mind for reception of the particular message. User Preferences can also be adapted through User support interfaces that allow for unexpected changes 229. Learned influences and effectiveness to a User after change can be tracked and recorded for future assessment increasing effectiveness of the system with time 230, 231.

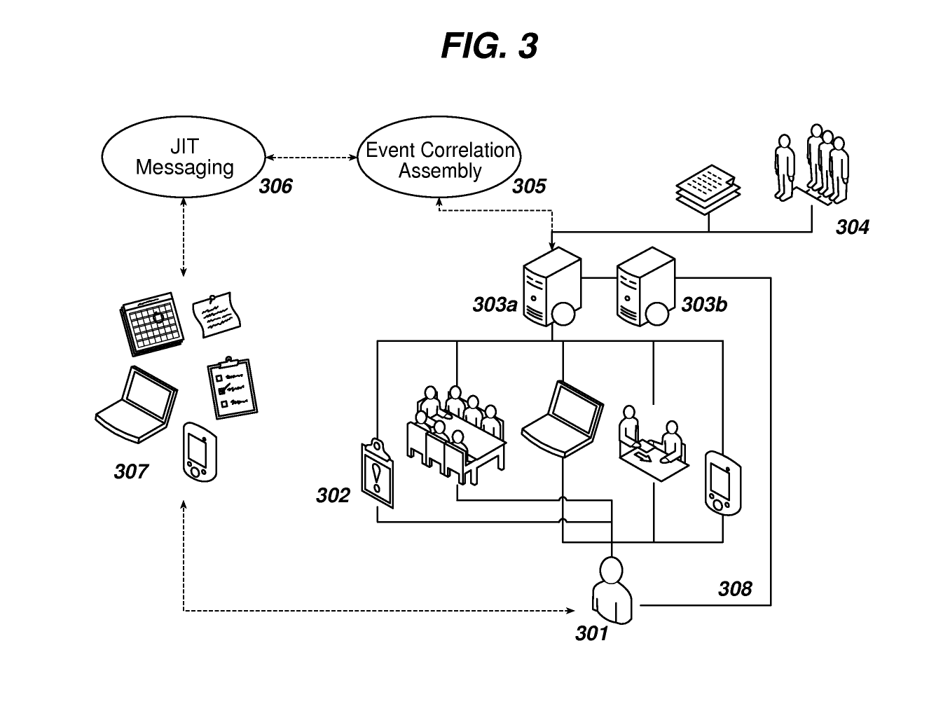

FIG. 3 is a schematic that illustrates a general sequence of events that may be followed when using the method and system of the present invention. Referring to FIG. 3, the User 301 of the system directly or indirectly provides data through different avenues 302. The data is gathered by a main server 303a, which also collects other information 304 that includes but is not limited to Normative Data and Geo-Social Data,. as explained above. An Emotion Detection System can also be included in the main server 303a, or can be included in a separate system 303b, linked to the main server. The main server 303a contains software executable to perform the functions described above providing Event Correlated Messaging 305 for the delivery of Smart Message(s) Holistic Message(s) to the User(s) 306. The message can be conveyed using the User Preferred means for the message and collect Present Responsiveness data throughout to update/increase preciseness of the systems functions for subsequent prospect messages [307, 308].

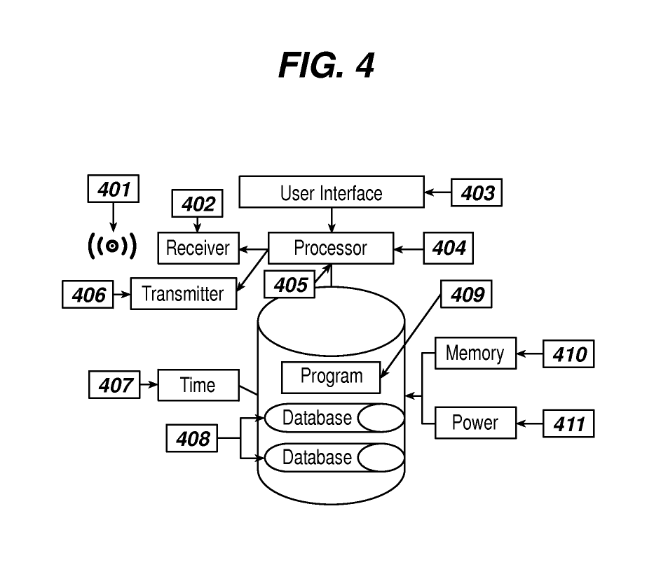

FIG. 4 is a schematic that illustrates a server that may be employed when using the method and system of the present invention. Referring to FIG. 4, the server can contain different means of receiving information 401. For example, Bluetooth technology, network/internet capabilities, etc. A receiver 402 can be used to allow the processor 405 to cause the data to be stored in specific databases 408 in uniform format and time. The data can then be used by a program 409 executable to perform the functions as described above by means of a series of algorithms. The server can additionally include a User interface 403, a processor for the software 405, a means of power 411, memory 410, and a means of keeping real time 407 in relation to the specific location of the individual (e.g., connecting the User's cell phone to the system to change time accordingly when required due to the User traveling.) A transmitter 406 in logical communication with the processor 405 transmits one or more Holistic Messages to one or more Network Access Devices associated with the User (not shown) based upon the order of precedence, the NOW state and the priority of messages as described above.

In addition to passive System Initiated Feedback that evolves over time, the system can also support User Initiated Feedback or activity through portable devices that provide the User with the option of interaction with the system. The interaction between the system and User can be an evolving loop, where new information fed by the User is considered along with new information from external sources and System Initiated Events when new messages are crafted. Based on portable devices, some that can be worn, the end User can influence the system for a new response. Some of the User worn devices can include for example, GPS, pedometer, glucose meter, etc. Through these devices, the system receives new Event data, Biometric Device Initiated Feedback and subsequently may incorporate it into the message generation. As a result, messages can continue to evolve over time, and the system can learn subtleties about the User that were not possible in past messaging models or with User self-reported data alone.

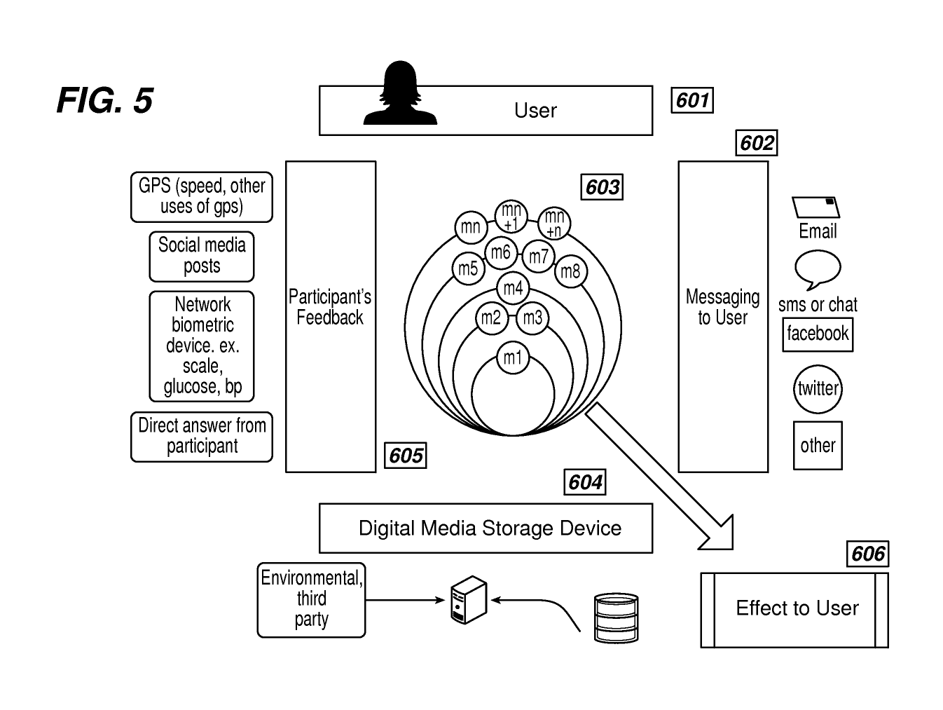

FIG. 5 is a schematic that illustrates feedback components that may be employed to generate and deliver Holistic Messages when using the system and method of the present invention. Referring to FIG. 5, at 601, a User can solicit advice. This can be a User's call for help to set himself/herself up for success through a future interaction. The system can react and respond accordingly. For example, in an alcohol addiction application, the User can preset a message to himself/herself to remind him/her at a later time about a goal, e.g., reminder not to drink at a wedding. The system can not only send the reminder, but also can provide the user with a healthier option at the correct timing and through the correct medium.

At 602, exemplary mediums for messaging the User are depicted. (E.g., social networking, sms, e-mail, chat, etc.) These mediums can be supported by a mobile application and provide an interface with a triage menu that can allow the system to provide immediate assistance to the User, e.g., to prevent an urge to smoke right now! or dig into larger problems. For example, I need help (cannot fall asleep), immediate help with symptoms can follow to find the bigger problem/root cause.

At 604, the Digital Media Storage Device server is depicted (also referred to as the “main server”). This server can be linked to other storage devices but generally stores data so that it knows when the right time is for the User to receive messages, what motivates the User to use the system, information inadvertently provided by the User of their support network, etc. At 605, exemplary means that can provide feedback from Users are shown. As depicted, these include but are not limited to GPS, social media posts, network biometric devices, or a direct answer from the participant. At 603, algorithms in the system can gather the relevant collected information for preparation of Holistic Messages. Furthermore, User feedback may prompt a short survey to lead the system to a more precise message (e.g., when do you notice this happening). In some circumstances, the feedback provided by the system can be by means of an action. For example, referring back to the User who is having trouble sleeping, the system can enable the User's cell phone, computer, etc. to provide white noise and assist the User properly. This can have a positive effect to the User and further encourage future participation of the User.

Additionally in other applications, data from sources inside and outside of “the system” may further be used to interpret human emotion and use this information to construct more timely and poignant responses, or to refrain from messaging a participant if the timing seems wrong. Because message relevance/usefulness expires quickly, by seizing on emotional spikes (the acuteness of someone's excitement for example) or patterns (e.g., User gets discouraged on Thursday nights right before spinning class) the system can make the message more timely, effective, and relevant. Information in the system's programs is treated carefully and is not as volatile as information posted on social networking sites, “scraped” from the sound of a person's voice in a conversation/IVR interaction, or in an immediate text response. Furthermore, the system can use the media to solicit new types of responses from a User and the provided response may help to determine the present state of emotion of the User. The system can also use emotions expressed in group settings (social media) to convey acceptance or rejection of an idea or process to our economic buyer (people who buy your insurance are talking about how great your website is . . . etc.). This information can provide additional data points to determine efficacy of programs or practices.

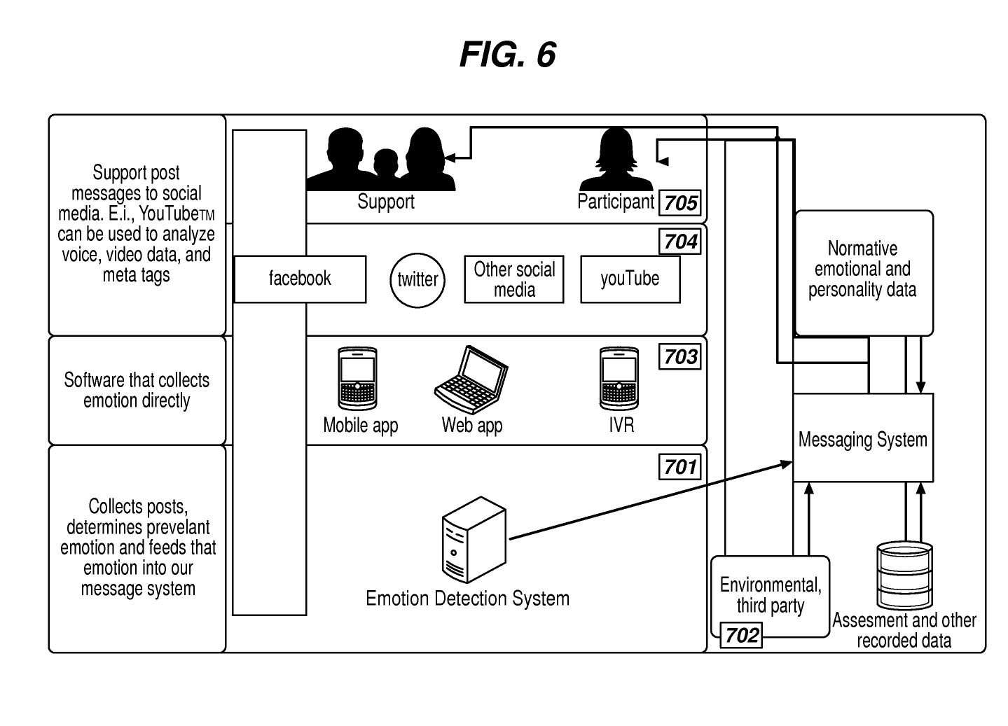

FIG. 6 is a schematic that illustrates emotion detection components that may be employed to generate and deliver Holistic Messages when using the system and method of the present invention. Referring to FIG. 6, at 701, an emotion detection system linked to the digital media storage system used for storage and messaging is depicted. In other embodiments, the system used for storage and messaging can integrate the emotion detection system. The emotion detection system functions with outside (the system's) data to determine the present state of emotion being conveyed by the User and tailor the electronic message according to that perceived emotion. Additionally at 702, the system can use the data to recognize patterns (e.g., every Tuesday the User is stressed about work). Based on recognized patterns, Normative Data and behavioral science can be implemented to provide guidance and attempt to help the user lower his/her stress level. To the contrary, if a strong negative emotion is detected by the system, the system can look for collective sensitivity from the community/population around a topic or effect of something on the population. (E.g., the occurrence of a natural disaster, such as an earthquake).

At 703, data input devices are depicted. User's posts in social networking sites, voice, video data, and Meta tags, or direct inputs of data regarding User's emotional state of mind, can be used for message generation and timing 704, 705. The system can interpret data collected, correlate it to the emotional state of the User, and generate code applied to the algorithms to filter and modify messages accordingly as described in previous sections. Correlating the messages to the emotional state of mind can maximize the effectiveness of the messages and respectively provide the User appropriate options and/or support that can help the User live a healthier life.

The foregoing examples are not intended to limit the scope of the present invention, which may be set out in the claims. In particular, various equivalents and substitutions will be recognized by those skilled in the art in view of the foregoing disclosure and these are contemplated to be within the scope of the invention.

What is claimed is:

1. A method for providing personalized message delivery to one or more users, comprising:
gathering data descriptive of two or more events in the one or more users life, wherein said two or more events include an emotion of said one or more users;
analyzing said data to determine priority of said messages; and
providing said personalized message delivery to said one or more user.

2. A system for providing personalized message delivery to one or more users, comprising:
at least one user interface;
a server, wherein said server comprises software, wherein said software gathers data descriptive of two or more events in the one or more users life, analyzes said data to determine priority of messages, and employs said priority of messages to determine personalized message delivery of said messages to said one or more users, wherein said two or more events include an emotion of said one or more users; and
a transmitter in communication with said processor and said at least one user interface, wherein said transmitter provides said personalized message delivery of said messages to said one or more users through the at least one user interface.
